(19) United States
(12) Patent Application Publication
(10) Pub. No.: US 2007/0284356 A1
(43) Pub. Date: Dec. 13, 2007

(54) Warming blanket with independent energy source

(76) Inventor: Carol Findlay, San Ramon, CA (US)

Correspondence Address: Nellcor Puritan Bennett LLC;c/o Fletcher Yoder PC, P.O. BOX 692289, HOUSTON, TX, 77269-2289, US

(21) Appl. No.: 11/450,617

(22) Filed: Jun. 9, 2006

(51) Int. Cl. H05B 3/00; H05B 3/34; H05B 3/54

(52) U.S. Cl. 219/212; 219/529; 219/545

(57) ABSTRACT

Embodiments of the present invention relate to a medical warming blanket. Specifically, embodiments of the present invention include a layer of medically rated fabric, a mixture of materials configured to produce heat upon activation, the mixture of materials contained adjacent the layer of medically rated fabric, and an activation mechanism configured to initiate heat production from the mixture of materials.

### BACKGROUND OF THE INVENTION

1. Field of the Invention

The present invention relates generally to medical warming systems. In particular, the present invention relates to a disposable, medically rated warming blanket that utilizes a non-electrical, integrated, and independent heating source.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Thermoregulation of an individual's core body temperature is desirable in many settings. For example, managing a patient's core body temperature is often critical during and after certain medical procedures (e.g., chemotherapy). Indeed, maintaining perioperative normothermia (i.e., a core body temperature of approximately 98.6 degrees Fahrenheit around the time of surgery) has been shown to lower mortality rates, minimize the occurrence of post operative wound infections, and reduce the length of hospital stays (i.e., patient recovery time), among other benefits. Additionally, thermoregulation can be useful or even essential in unforeseen emergency situations. For example, individuals caught outside in freezing conditions may require thermoregulation to survive the freezing temperatures.

Warming blanket systems that emanate heat are often used for thermoregulation. For example, pre-heated cotton blankets, electric blankets, or hot air blanket systems may be utilized to maintain an individual's core body temperature at an acceptable level. Electric blankets generally convert electricity into heat by passing electricity through a resistant metal disposed within the blanket, thus creating heat from friction produced by electrons passing through the resistant metal. Hot air blanket systems typically include a blower that forces air through a heater (e.g., an electric heater) and into a blanket. The heater warms the air and the blanket distributes the warmed air uniformly to the patient. Pre-heated cotton blankets are generally heated in an electric heater or oven, placed over a patient, and replaced with a freshly heated cotton blanket once the heat has substantially or completely dissipated.

These existing techniques for thermoregulation each exhibit certain drawbacks. For example, each of the techniques discussed above generally require continual heating or reheating of the blankets over an extended period of time using separate power sources, such as AC power, cumbersome batteries, and ovens. Additionally, as discussed above, the hot air blankets require the use of blowers, which have specific drawbacks such as being bulky and loud. Further, one of the drawbacks of pre-heated blankets is that they generally cannot maintain a constant temperature. Once a pre-heated blanket is removed from its heat source (e.g., oven) it generally begins to lose heat and cannot be reheated without placing it back in the heat source. It should also be noted that monitoring blanket temperature may be difficult with certain existing thermoregulation techniques.

### BRIEF DESCRIPTION OF THE DRAWINGS

Advantages of the invention may become apparent upon reading the following detailed description and upon reference to the drawings in which:

FIG. 1 is a perspective view of a warming blanket with an independent heat source in accordance with an exemplary embodiment of the present invention;

FIG. 2 is a perspective view of a warming blanket with a plurality of attachable and detachable pouches containing independent heat sources in accordance with an exemplary embodiment of the present invention;

FIG. 3 is a cross-sectional view of a warming blanket with an independent heat source and a sealing layer activation mechanism in accordance with an exemplary embodiment of the present invention taken along line 3-3 of FIG. 1;

FIG. 4 is a cross-sectional view of a warming blanket with an independent heat source in accordance with an exemplary embodiment of the present invention;

FIG. 5 is a perspective view of a warming blanket with an independent heat source disposed within an airtight bag in accordance with an exemplary embodiment of the present invention;

FIG. 6 is a perspective view of a warming blanket with an independent heat source, wherein the blanket forms an envelope for holding an infant in accordance with an exemplary embodiment of the present invention;

FIG. 7 is an alternate cross-sectional view taken along line 3-3 of FIG. 1 of a warming blanket, wherein supercooled sodium acetate solution and a triggering mechanism are disposed within a sealed container retained between first and second layers of the blanket by a seal in accordance with an exemplary embodiment of the present invention;

FIG. 8 is a cutaway top view of a warming blanket wherein a portion of a heat source is removed and wherein the heat source includes a metal strip with multiple notches disposed along the length of the metal strip in accordance with an exemplary embodiment of the present invention;

FIG. 9 is a perspective view of a warming blanket with an independent heat source and a plurality of integral lighted thermometers in accordance with an exemplary embodiment of the present invention;

FIG. 10 is a perspective view of a warming blanket with an independent heat source and a single integral lighted thermometer, wherein an indicating component of the thermometer is coupled to multiple sections of the blanket in accordance with an exemplary embodiment of the present invention;

FIG. 11 is a block diagram of a method of manufacturing a medical warming blanket in accordance with an exemplary embodiment of the present invention; and

FIG. 12 is a block diagram of a method of using a medical warming blanket in accordance with an exemplary embodiment of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention are directed to a warming blanket with an independent heat source. For example, present embodiments include a blanket wherein fabric forming the blanket body holds at least one independent heat source adjacent to the fabric. The independent heat source may be configured to produce heat upon activation without requiring utilization of or connection to any separate source of energy (e.g., AC power, a battery, or an oven). For example, the heat source may include chemicals that react to produce heat. Accordingly, embodiments of the present invention are totally portable. Additionally, in some embodiments, the blanket includes medically rated fabric.

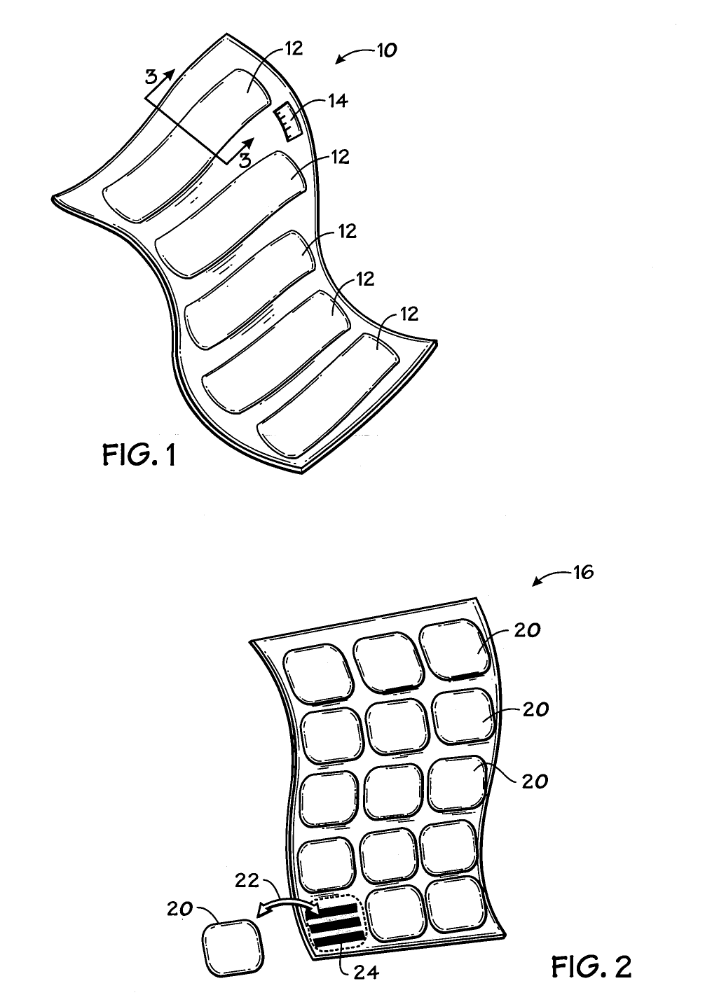

FIG. 1 is a perspective view of a warming blanket 10 with an independent heat source 12 and a temperature indicator 14 in accordance with an exemplary embodiment of the present invention. The independent heat source may include material or a mixture of materials that produce heat when activated (e.g., exposed to air or mixed together). The blanket 10 may be referred to as medically rated if it comprises medically rated fabric or material. For example, the blanket 10 may be at least partially formed by fabrics that do not lint during surgery (e.g., tear resistant fabrics), fabrics that have anti-microbial repellent capabilities, and/or fabrics with liquid repellent capabilities. Indeed, in one embodiment, the blanket 10 comprises material that has microscopic pores, which prevent liquid penetration while allowing air to circulate through the blanket 10.

Possibly, in addition to using medically rated material, the materials forming the blanket 10 may comprise inexpensive and disposable materials that facilitate single-use functionality. Single-use functionality increases usage capabilities of the blanket 10. For example, a patient can be sent home with the blanket 10 to keep the patient warm during transportation. Because the blanket 10 will be disposed of anyway, no additional expenses are incurred from loss of the blanket 10. After the blanket 10 has satisfied its purpose, the patient can simply dispose of it at home. Additionally, it should be noted that disposable products are generally cost effective and time saving. For example, expenses and time related to cleansing the blanket 10 for reuse can be eliminated by making the blanket 10 disposable.

The independent heat source 12 may be incorporated into the fabric of the blanket 10 or coupled to the blanket 10. For example, in the embodiment illustrated by FIG. 1, the heat source 12 comprises a mixture of materials configured to produce heat upon activation. This mixture of materials is contained within pockets disposed within the blanket 10 and along its length. A number of such pockets are utilized to prevent the mixture of materials from shifting to one side of the blanket. In other embodiments, the mixture of materials is simply disposed evenly throughout the blanket or is prevented from shifting to one side by a labyrinth of seals stitched into the blanket 10.

FIG. 2 illustrates a blanket 16 with a plurality of containers or pouches 20 that are coupleable to the blanket 16. The pouches 20 include heat source 12. Additionally, the pouches 20 are attachable and detachable from the blanket 16, as illustrated by arrow 22, which allows a user to determine how much heat will be supplied by attaching or detaching a desired number of pouches 20 to the blanket 16. The pouches 20 can be attached using a coupling mechanism 24 (e.g., Velcro, buttons, receptacles) on the blanket 16.

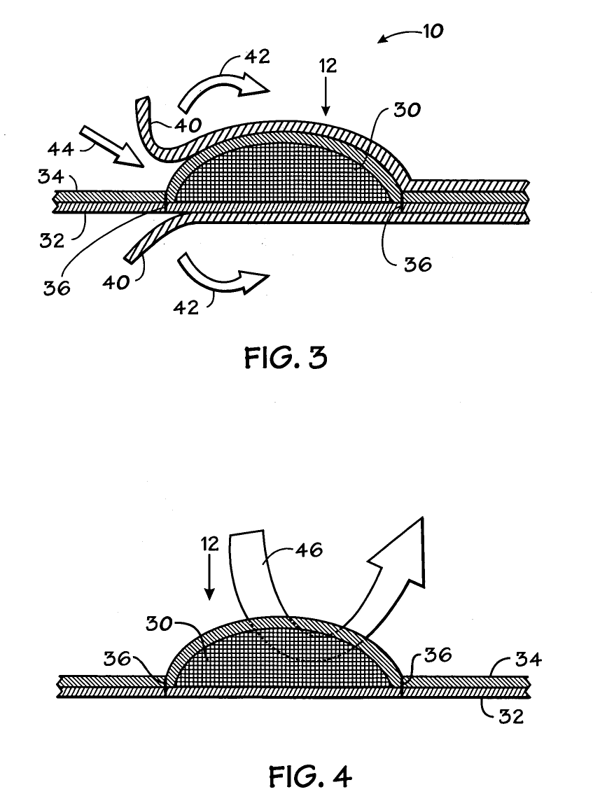

FIG. 3 is a cross-sectional view of the blanket 10 and the independent heat source 12 taken along line 3-3 of FIG. 1. Specifically, FIG. 3 illustrates a material 30, such as iron powder, that makes up the active portion of the heat source 12 disposed between a first layer 32 and a second layer 34 of the blanket 10. The fabric layers 32 and 34 are held together by a seal 36 (e.g., stitching) around the heat source 12. The seal 36 forms an enclosed space to contain the material 30, which prevents the material 30 from dispersing or accumulating in a non-designated area. This containment of the material 30 may also improve functionality of the material 30 by preventing over exposure to air or some other activation mechanism. Indeed, in embodiments activated by air, heat levels deliverable by the heat source 12 may be predetermined by configuring the heat source 12 such that a designated amount of air reaches the material 30 over a designated period of time when exposed, thus controlling heat emission.

Because the heat emitting reaction of the material 30 typically only lasts for a certain amount of time (e.g., until the iron powder has completely oxidized), it is desirable to avoid initiation of the reaction until heating is desired. Accordingly, a trigger mechanism may be incorporated to initiate heating and prevent premature activation. Specifically, for embodiments activated by exposure to air, an airtight or substantially airtight sealing layer may be employed. For example, in the embodiment illustrated by FIG. 3, airtight strips 40 (e.g., plastic strips) are employed over the air-permeable layers 32 and 34. Such strips may be put in place during manufacture of the warming blanket 10 to substantially or completely prevent air from reaching the material 30. These strips 40 are removed or peeled away from the heat source 12, as illustrated by arrows 42, to initiate heating. In one embodiment, the strips 40 comprise plastic layers covering the entire front and back surfaces of the blanket 10. Once removed, air enters the heat source 12 via the layers 32 and/or 34, as illustrated by arrow 44. When air mixes with the exposed material 30, the heating reaction can begin.

In the embodiment illustrated by FIG. 4, the strips 40 have been completely removed from the heat source 12 and the heat source 12 is being activated by exposure to air. Specifically, in the illustrated embodiment, the material 30 of the heat source 12 is reacting with air to produce heat. The material 30 may include a mixture of iron powder, water, vermiculite, carbon, and salt. The air used in the reaction is allowed to circulate through the material 30 via small holes in the second layer 34, as illustrated by arrow 46. It should be noted that in other embodiments, air is able to circulate through either or both layers 32 and 34. When the material 30 is exposed to the air, the iron oxidizes with the air, creating heat. The other components of the material 30 (e.g., water, vermiculite, carbon, and salt) facilitate and/or control the reaction, thus controlling the heat. In some embodiments, the reaction may be controlled by limiting access to the material 30 through either or both of the layers 32 and 34. For example, the size of holes in fabric of the layers 32 and 34 may be used to control the rate of exposure of the material 30 to air.

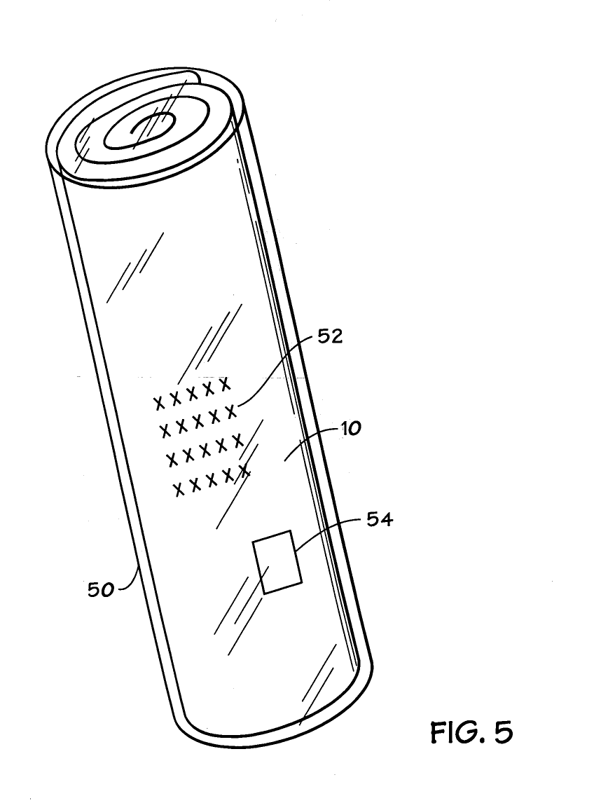

FIG. 5 is a perspective view of the blanket 10 disposed within an airtight bag 50, which operates as the sealing layer. During manufacture, the entire blanket 10 may be rolled up and sealed or disposed in the airtight bag 50 to prevent initiation or continuation of an oxidation reaction. The airtight bag 50 not only operates to contain, protect, and facilitate storage of the blanket 10; removal of the blanket 10 from the airtight bag 50 exposes the blanket 10 to air and thus initiates heating of the blanket 10 from the heat source 12.

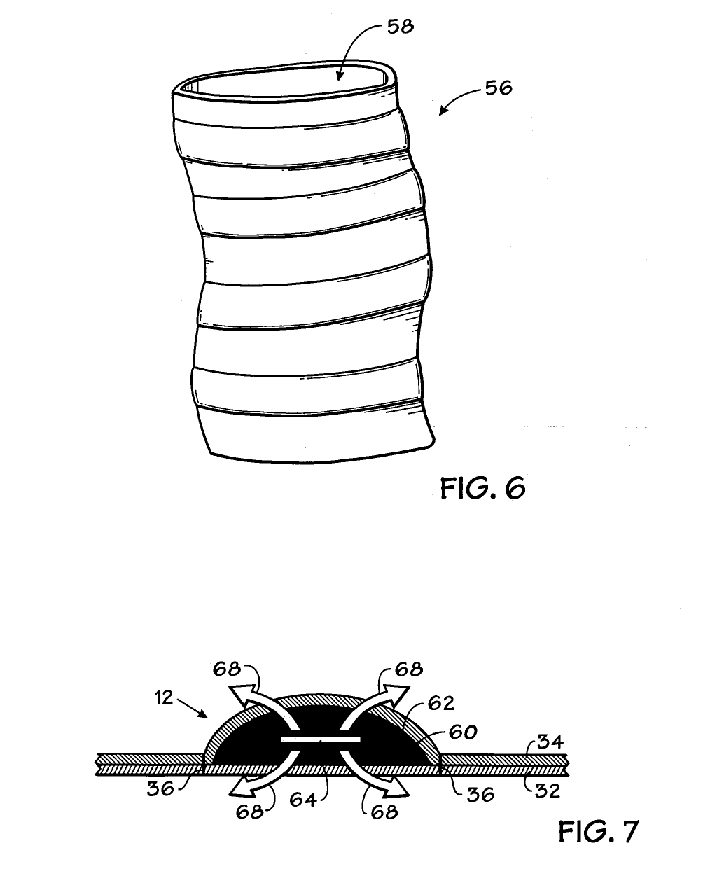

It should also be noted that FIG. 5 illustrates various safety and efficiency features in accordance with present embodiments. For example, the blanket 10 illustrated in FIG. 5 includes operation instructions 52 (e.g., pictorial representations or text) disposed directly on the blanket 10, thus eliminating the use of separate materials with directions for use. Additionally, a color coding mechanism 54 may be illustrated directly on the blanket 10. The color coding mechanism 54 may indicate that a blanket color or patch color on the blanket 10 designates certain uses for the blanket 10 (e.g., blue for adults, yellow for children, and green for newborns). For example, certain blankets may be sized or shaped for use with certain types of patients. Indeed, in one embodiment, as illustrated by FIG. 6, a warming blanket 56 comprises an envelope 58, much like a sleeping bag, to hold an infant. The instructions 52, color coding 54, and various shape and size configurations may improve use of the blanket 10.

In some embodiments, as illustrated by FIG. 7, the heat source 12 may include a supercoolable solution 60 stored within a sealed container 62 (e.g., a vinyl pouch). For example, the heat source 12 may include a supercooled sodium acetate solution 60 disposed within the sealed container 62, which is retained between the first and second layers 32 and 34 of the blanket 10 by the seal 36. The solution 60 is made by dissolving the appropriate amount of sodium acetate in the desired amount of water to ensure that activation of the heat source 12 does not occur unintentionally at ambient or use temperature. In one embodiment, the solution is prepared such that under normal conditions and in an open container, the solution 60 would change from a liquid to a solid (i.e., freeze) at 130 degrees Fahrenheit. By placing the solution in the sealed container 62 instead of an open container, the solution can be cooled well below the freezing temperature. This supercooled solution 60 can be activated to produce heat by triggering a chain reaction with an activation mechanism, such as a flexible metal strip 64 disposed within the solution 60.

As set forth above, the activation mechanism may include an activator strip such as the metal strip 64 (e.g., a flexible strip of stainless steel). Further, the metal strip 64 may include notches 66 that are cut into the metal strip 64. For example, FIG. 8 is a cutaway top view of the heat source 12, wherein the metal strip 64 is shown with multiple notches 66 disposed along the length of the metal strip 64. A user can trigger the activation mechanism (e.g., metal strip 64) by grabbing the heat source 12 and twisting or flexing it, which in turn twists and flexes the metal strip 64 component of the heat source 12, as illustrated by arrows 68 in FIG. 7. As the metal strip 64 is twisted or flexed, activation of the solution 60 occurs. Specifically, in the illustrated embodiment, due to the action of the metal strip 64, crystals of sodium acetate are initially produced near the notches 66. These crystals trigger crystal propagation throughout the solution 60 component of the heat source 12. As the solution crystallizes, an even heat flow is produced. The physical restriction of the crystals allows for control of the maximum heat produced. Indeed, in some embodiments, temperature limits are defined by the manufacturer specifications (e.g., designated size of sealed container 62 and amount of solution 60 disposed therein).

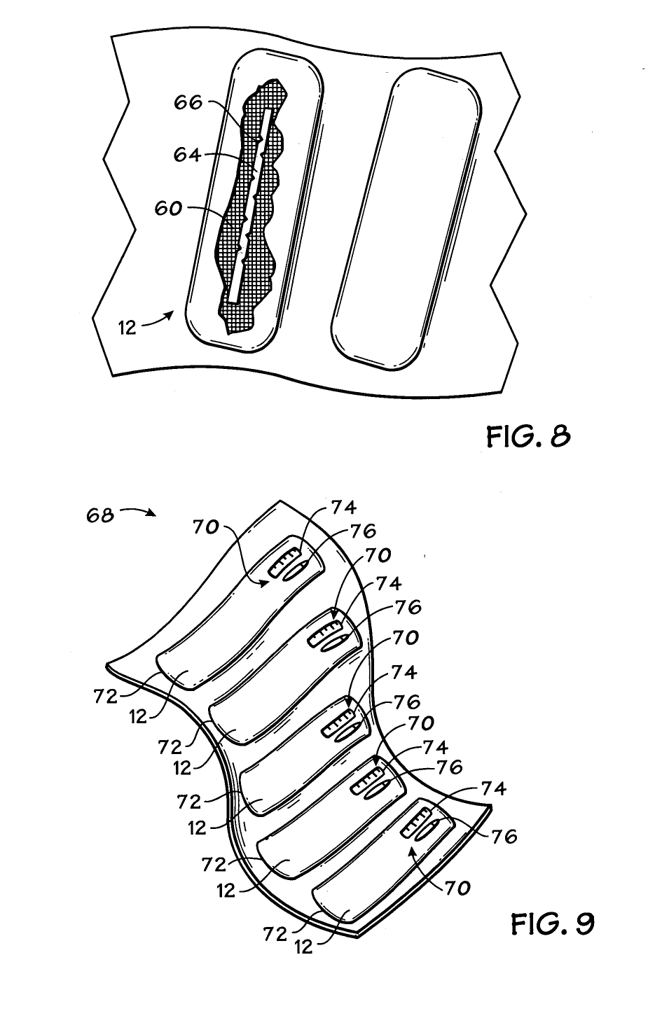

FIG. 9 is a perspective view of an exemplary warming blanket 68 with the independent heat source 12 and a plurality of integral lighted thermometers 70. Specifically, the blanket 68 illustrated in FIG. 9 includes multiple pockets 72 of heating material forming the heat source 12, wherein each of the pockets 72 is coupled to a corresponding lighted thermometer 70. In the illustrated embodiment, the lighted thermometers 70 include a temperature indicating component 74 and a light emitting component 76 (e.g., a light stick).

The temperature indicating component 74 may include any instrument for measuring temperature and the light source 76 may include any form of light source. In one embodiment, the temperature indicating component 74 is a liquid crystal thermometer and the light 76 is a chemically activatable light (e.g., a tube with a chemiluminesent material disposed therein). The liquid crystal thermometer may include a thin flexible strip having multiple layers containing liquid crystals that reflect colored light only at certain temperatures. In this embodiment, the liquid crystal thermometer may display current temperature as brightly colored numbers, which are made visible by the chemical light (e.g., a light stick) that is near or incorporated with the temperature indicating component 74. These features may enable a care giver to quickly and efficiently confirm that the blanket 68 is still heating a patient without having to disturb the patient. Indeed, having the integral light source 76 will allow for temperature confirmation even in a dark room. Additionally, using a chemical light for the light source 76 is beneficial because it is disposable and does not require electricity (e.g., batteries).

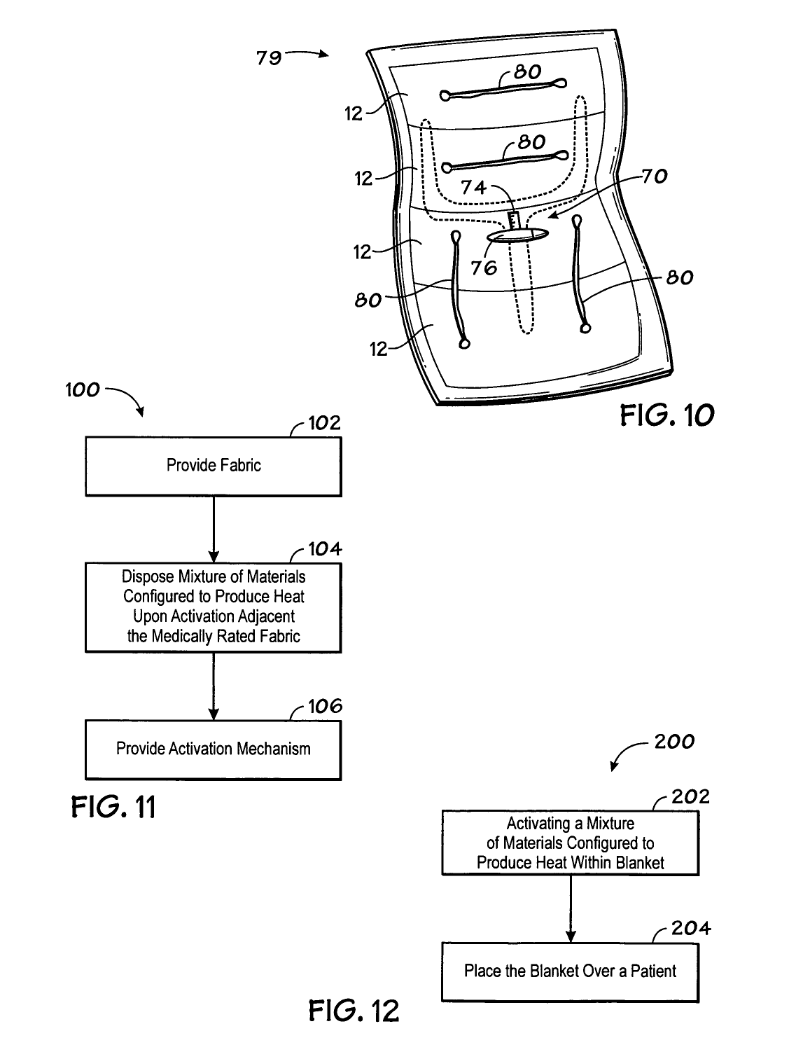

It should be noted that in some embodiments, a single lighted thermometer 70 is utilized as illustrated in FIG. 10, instead of the multiple thermometers discussed above. Indeed, in the embodiment illustrated by FIG. 10, the temperature indicating component 74 is coupled to multiple sections of the blanket 79 to provide an overall temperature reading for the entire blanket 79. Further, the single light source 76 illustrated in FIG. 10 facilitates viewing of the temperature indicating component 74. This embodiment may reduce costs associated with provision of multiple lighted thermometers 70 and improve convenience with respect to checking temperatures. It should also be noted that FIG. 10 illustrates a plurality of slits 80 in the blanket 79 that enables a care giver to access portions of a patient's body through the blanket 79. This can be beneficial during surgery or treatment of a patient being warmed by the blanket 79. For example, a doctor can treat a patient's leg through the blanket 79 without compromising the warming effects and associated benefits of the blanket 79. The plurality of slits 80 may be incorporated in various embodiments of the present invention.

FIG. 11 is a block diagram of a method of manufacturing a warming blanket such as the blankets discussed above. The method is generally referred to by reference number 100. Specifically, block 102 of method 100 represents providing a layer of fabric such as medically rated material. For example, block 102 may include providing a sheet of fabric that is sterile, liquid repellant, anti-bacterial, anti-microbial, and/or tear resistant (e.g., material that does not lint). These features facilitate use of the blanket in a hospital setting. In other embodiments, the blanket may be manufactured of material that is readily disposable and/or medically rated, thus, improving efficiency of use, reducing associated cleaning costs, and eliminating potential for contamination.

Block 104 represents disposing a mixture of materials configured to produce heat upon activation adjacent the layer of fabric. For example, block 104 may include incorporating a mixture of materials that react by expelling heat when exposed to oxygen or a mixture of materials that crystallize and expel heat when activated by a trigger, as discussed in detail above. The mixture may be contained directly adjacent the layer of fabric or within a separate container (e.g., a sealed vinyl bag) that is adjacent the fabric.

Block 106 represents providing an activation mechanism configured to initiate heat production from the mixture of materials. For example, the activation mechanism may include a plastic strip that when removed exposes the mixture of materials to oxygen or a flexible strip that activates crystallization of the mixture. It should also be noted that method 100 may also include providing a temperature indicating mechanism (e.g., a liquid crystal thermometer) and/or a light source (e.g., a glow stick) as components of the blanket.

FIG. 12 is a block diagram of a method of using a warming blanket in accordance with an exemplary embodiment of the present invention. This method of use is generally referred to by reference number 200. Specifically, block 202 represents activating a mixture of materials configured to produce heat upon activation. For example, this activation may include exposing the mixture of materials to oxygen or activating crystallization in the mixture of materials by twisting or bending a trigger mechanism. Block 204 represents placing the fabric over a patient. In some embodiments, block 204 includes procedures that prevent the blanket from becoming contaminated. For example, the blanket may be removed from a sterilized plastic cover and placed over the patient without contacting anything other than the patient with the fabric. It should also be noted that method 200 may include checking a temperature of the blanket by observing a temperature indicator. For example, a user may activate a light stick that is integral to the blanket to assist in viewing a liquid crystal thermometer that is also integral to the blanket.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A medical warming blanket, comprising:
a layer of fabric;
an independent heat source configured to produce heat upon activation, the independent heat source contained adjacent the layer of fabric; and
an activation mechanism configured to initiate independent heat production from the independent heat source.

2. The medical warming blanket of claim 1, wherein the independent heat source comprises a mixture of iron, water, cellulose, vermiculite, activated carbon, and salt.

3. The medical warming blanket of claim 2, wherein the activation mechanism comprises a removable airtight layer configured to substantially prevent air from reaching the independent heat source until the airtight layer is removed.

4. The medical warming blanket of claim 3, wherein the airtight layer comprises a plastic bag configured to contain the entire medical warming blanket.

5. The medical warming blanket of claim 3, wherein the airtight layer comprises a removable plastic strip disposed on the medical warming blanket.

6. The medical warming blanket of claim 1, wherein the independent heat source comprises a supercoolable solution.

7. The medical warming blanket of claim 6, wherein the supercoolable solution comprises sodium acetate contained within a sealed vinyl pouch, wherein the sealed vinyl pouch is coupled to the medically rated fabric.

8. The medical warming blanket of claim 6, wherein the activation mechanism comprises a flexible activator strip disposed within the supercoolable solution, the flexible activator strip configured to initiate crystallization of the supercoolable solution when flexed.

9. The medical warming blanket of claim 1, comprising a temperature indicator disposed on the medical warming blanket.

10. The medical warming blanket of claim 9, wherein the temperature indicator comprises a light emitting element.

11. The medical warming blanket of claim 10, wherein the light emitting element comprises chemiluminesent material.

12. The medical warming device of claim 9, wherein the temperature indicator comprises a liquid crystal thermometer.

13. The medical warming device of claim 1, wherein the fabric is medically rated.

14. The medical warming device of claim 1, wherein the independent heat source includes a mixture of materials that produce heat when exposed to air.

15. A method of manufacturing a medical warming blanket, comprising:
providing a layer of fabric;
disposing an independent heat source configured to produce heat upon activation adjacent the layer of fabric; and
providing an activation mechanism configured to initiate heat production from the independent heat source.

16. The method of claim 15, comprising disposing the independent heat source within a sealed container adjacent the fabric.

17. The method of claim 15, wherein providing the activation mechanism comprises sealing the independent heat source behind a removable airtight seal.

18. The method of claim 15, comprising coupling a temperature indicating component to the medical warming blanket adjacent the independent heat source.

19. The method of claim 15, comprising coupling a lighted thermometer to the medical warming blanket adjacent the independent heat source.

20. The method of claim 15, comprising disposing a mixture of chemicals configured to produce heat upon exposure to oxygen adjacent the layer of fabric as the independent heat source.

21. The method of claim 15, comprising providing medically rate fabric as the layer fabric.

22. A method of operation of a medical warming blanket, comprising:
holding an independent heat source configured to produce heat upon activation adjacent a layer of fabric; and
emanating heat upon activation of the independent heat source.

23. The method of claim 22, comprising providing a visible indication of a temperature of the medical warming blanket.

24. The method of claim 23, comprising emanating a light near the visible indication of the temperature of the warming blanket.

26. The method of claim 22, wherein the independent heat source is a mixture of materials that produce heat upon activation.

27. A method of using a medical warming blanket, comprising:
activating an independent heat source configured to produce heat upon activation disposed adjacent a layer of medically rated fabric; and
placing the medically rated fabric over a patient.

28. The method of claim 27, comprising exposing the independent heat source to air to initiate heating, wherein the independent heat source includes a chemical configured to produce heat when exposed to oxygen.

29. The method of claim 27, comprising manipulating a metal strip disposed within the independent heat source to initiate heating.

30. The method of claim 27, comprising observing an integral temperature indicator to determine a temperature level of the medical warming blanket.

31. The method of claim 27, comprising activating a chemical light source to facilitate observation of an integral temperature indicator that displays a temperature level of the medical warming blanket.
